(19) United States
(12) Patent Application Publication
(10) Pub. No.: US 2006/0017278 A1
(43) Pub. Date: Jan. 26, 2006

(54) Bound print media advertising booklet with detachable perforated segments

(76) Inventor: Cynthia A. Wood, Temecula, CA (US)

Correspondence Address: Cynthia A. Wood, 41565 Corte Seda, Temecula, CA, 92592, US

(21) Appl. No.: 11/089,554

(22) Filed: Mar. 5, 2004

(51) Int. Cl. B42D 15/00

(52) U.S. Cl. 283/56

(57) ABSTRACT

A booklet for the purpose of print media coupon advertisement comprised of a plurality of pages which have been bound together. As a result of perforations distal to the binding site, segments of pages containing coupon advertisements are easily removable from the conveniently sized booklet without effecting the integrity of the binding

### FIELD OF THE INVENTION

The present invention relates to a booklet of coupon advertisements which is constructed similarly to a check book or bank deposit book in order to facilitate the redemption of coupons as a result of increased convenience through a variety of improvements.
1. The size of the booklet is similar but not limited to the approximate dimensions of a check book.
2. The booklet has binding which may be comprised of glue, stitching or any combination thereof, applied to a superior or lateral aspect to facilitate holding the booklet together after portions of pages are removed for the purpose of redemption.
3. Portions of the pages contain one or more linear series of perforations to facilitate the detachment of said portions without compromising the integrity of the binding or adjacent pages.
4. Booklet may have sections of pages that are color coded to separate categories of coupons by type of service for which they may be redeemed.
5. Booklet may contain index or list of business coupons contained within.

### DESCRIPTION OF THE PRIOR ART

Coupons are a frequent method of advertising and there are many forms of print media coupon advertising available. There are however none which contain all of the features of the current embodiment which was designed to facilitate use through a variety of improvements which create a coupon booklet similar in functionality to a check book. Perforated segments on pages have been designed and used for coupon production for many years in order to facilitate coupon redemption use with convenience. Up to this time however, there has been no design for a conveniently sized, perforated publication with physical similarities to a check book, with which people are accustomed to using and carrying on their person.

### BRIEF DESCRIPTION OF THE DRAWINGS

FIG. 1 is a front elevation view of the booklet with binding (1) on left lateral portion of booklet. In this drawing, cover (2) is not perforated and is closed so perforations are not visible. The plurality of the pages is visible (3).

FIG. 2 is a front elevation view with cover (2) lifted so perforations are visible. The two areas of broken lines (6) & (7) represent perforations which result in easily removable segments (4), while a portion of page (5) remains attached to binding to allow for removal of segment without interrupting the integrity of the binding.

FIG. 3 is a left front elevation view of booklet with binding on top portion of booklet, with cover (2) open to expose perforations (6), (7) which allow for different size segments (5) to be detached from booklet with out causing an impairment to the integrity of the binding (1).

### BRIEF DESCRIPTION OF THE DRAWINGS

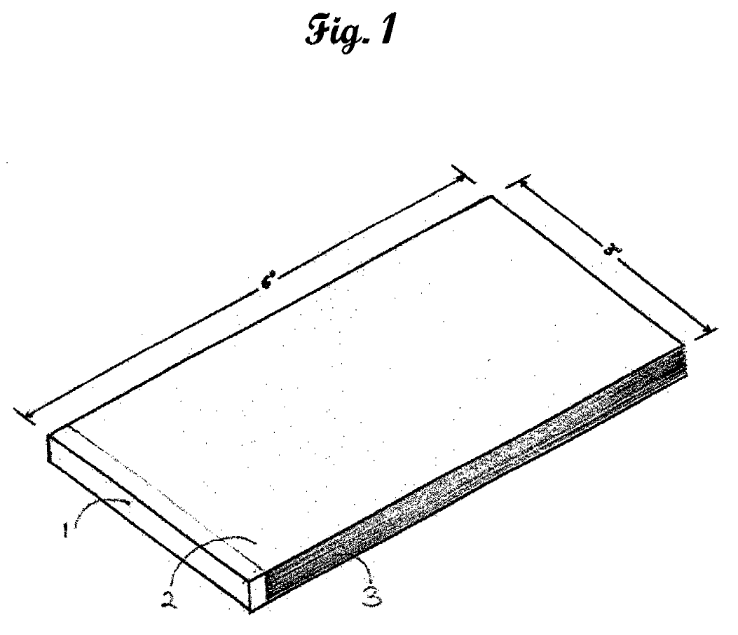

FIG. 1 is a front elevation view of the booklet with binding (1) on left lateral portion of booklet. In this drawing, cover (2) is not perforated and is closed so perforations are not visible. The plurality of the pages is visible (3).

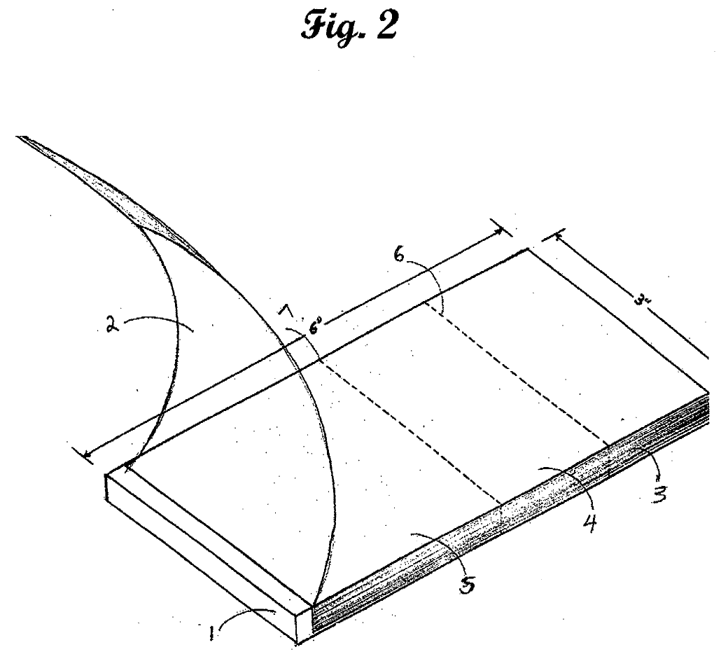

FIG. 2 is a front elevation view with cover (2) lifted so perforations are visible. The two areas of broken lines (6) & (7) represent perforations which result in easily removable segments (4), while a portion of page (5) remains attached to binding to allow for removal of segment without interrupting the integrity of the binding.

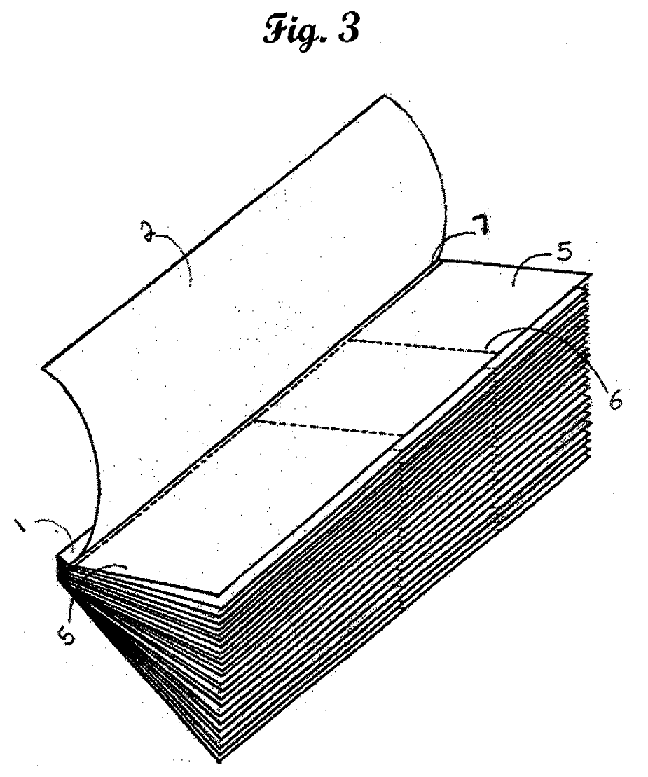

FIG. 3 is a left front elevation view of booklet with binding on top portion of booklet, with cover (2) open to expose perforations (6), (7) which allow for different size segments (5) to be detached from booklet with out causing an impairment to the integrity of the binding (1).

What is claimed is:

1. A plurality of pages are bound together to create a booklet.

2. A booklet wherein the pages contain printed coupons for the purpose of redemption, advertisement or promotion of a business to consumers.

3. The booklet of claim 1 having a bound side, two unbound sides perpendicular to the bound side and an unbound side parallel to the unbound side.

4. The booklet of claim 1 consisting of one or more linear series of perforations for the purpose of allowing portions of the booklet to be removed without altering the integrity of the binding.

5. The booklet of claim 1 wherein the pages are comprised of paper.

6. The booklet of claim 1 wherein the linear series of perforations are located on one or more section of the pages to allow for easy detachment of one or more segments.

7. The booklet of claim 1 wherein the detachable portions can be of varying dimensions and quantities on each page as long as the integrity of the binding is not affected when the perforated portions are detached.

8. The booklet of claim 1 wherein the weight or quality of the paper used to create the booklet can be of similar or varying qualities.

9. The booklet of claim 1 which can be bound with the application of adhesive, with stitch binding or any method that facilitates the containment of the pages as one unit or booklet notwithstanding the removal of segments of the pages.

10. The booklet of claim 1 which is of a size so as to facilitate the convenient use of publication, similar to but not limited to the size of a standard check book.

11. The booklet of claim 1 wherein the the length is approximately two times the measurement of the width.

12. The booklet of claim 1 wherein the cover of booklet may or may not be perforated.
